(19) United States
(12) Patent Application Publication
(10) Pub. No.: US 2012/0209586 A1
(43) Pub. Date: Aug. 16, 2012

(54) Contextual Demonstration of Applications Hosted on Multi-Tenant Database Systems

(75) Inventors: Anna Bonner Mieritz, Montana, CA (US); Kathryn Jurick, Seattle, WA (US); Melissa Anne Federoff, Chicago, IL (US); Andrea Irwin, San Francisco, CA (US)

(73) Assignee: salesforce.com, inc., San Francisco, CA (US)

(21) Appl. No.: 13/282,410

(22) Filed: Oct. 26, 2011

Related U.S. Application Data
(60) Provisional application No. 61/443,625, filed on Feb. 16, 2011.

(51) Int. Cl. G06F 9/455

(52) U.S. Cl. 703/22

(57) ABSTRACT

Mechanisms and methods for providing a contextual demonstration of a customer relationship management (CRM) system can be tailored to illustrate the user-specific benefits of the CRM. An example method can include sending instructions to display a user interface having at least one pre-defined field on an electronic device's display. An explicit input corresponding to one of the pre-defined fields and made at the user interface can be received. A selection of the type of simulation can be received. The explicit input and the selected type of simulation can be processed to generate at least one output. Each output can represent a correlation between the explicit input and at least one of the at least one pre-defined fields. A presentation can be generated based at least in part on the at least one output and the selection of the type of simulation. The presentation can be displayed at the user interface.

### CLAIM OF PRIORITY

This application claims the benefit of U.S. Provisional patent application Ser. No. 10/443,625 entitled SYSTEMS AND METHODS FOR PROVIDING CONTEXTUAL CRM CONTENT, by Mieritz et al., filed Feb. 16, 2011, the entire contents of which are incorporated herein by reference.

### FIELD OF THE INVENTION

One or more implementations relate generally to interactive and customizable applications, and more specifically to preview demonstrations of applications hosted on multi-tenant database systems, such as customer relationship management applications.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional preview or trial demonstrations of applications and products, the previews or trial demonstrations typically include static content. That is, the content provided in the preview or trial demonstration is predetermined and non-customizable. For example, conventional preview demonstrations provide a generic simulation of the application. The same preview demonstration is provided to whomever views the preview demonstration. In other words, preview demonstrations are typically generated independent of the recipient of the preview demonstration, where the preview demonstration is viewed, and when the preview demonstration is viewed.

Additionally, conventional previews or trial demonstration of products and applications present the user with all of the available features of the product or application, which can overwhelm the user. The user can also lose his attention and desire to continue viewing the preview or trial demonstration and prematurely end the preview of trial demonstration before accessing or previewing the features the product or application that may be relevant or beneficial to the user. As a result, the user can decline to purchase the product or application because the user did not realize the benefits of the product or application specific to him based on the preview or trial demonstration.

### BRIEF SUMMARY

In accordance with embodiments, there are provided mechanisms and methods for contextual demonstration of a product. For example, the product can include an application hosted on a multi-tenant database, a customer relationship management system, software programs, web applications, products, services, or any other purchasable or subscribable item. These mechanisms and methods for contextual demonstration of a product disclosed herein can provide a demonstration which can be tailored or customized to the recipient (for example, the user) of the contextual demonstration. For example, the contextual demonstration can be customized based on user-defined inputs, the location where the user is viewing the contextual demonstration, when the user is viewing the contextual demonstration, implicit inputs, and inferences drawn therefrom. Additionally, these mechanism and methods for contextual demonstration of a product can enable embodiments that present a contextual demonstration of the user-specific benefits of the product. For example, the contextual demonstration can present benefits which are tailored to the user based on any or all of the following: user-defined inputs, the location where the user is viewing the contextual demonstration, when the user is viewing the contextual demonstration, implicit inputs, and inferences drawn therefrom.

In one embodiment and by way of example, a method for contextual demonstration of a product, the method embodiment can include sending instructions to display a user interface. The user interface can have at least one pre-defined field displayed on an electronic device's display. The method can include receiving an explicit input made at the user interface and corresponding to one of the pre-defined fields. The method can include receiving a selection of the type of simulation to be demonstrated in the presentation. For example, the type of simulation can correspond to the focus of the presentation to be generated. For example, the focus can be for sales use, service use, and mobile use. The explicit input and the selected type of simulation can be processed to generate at least one output. Each output can represent a correlation between the explicit input and at least one of the at least one pre-defined fields. A presentation can be generated based at least in part on the at least one output and the selection of the type of simulation. The presentation can be displayed at the user interface. For example, the presentation can be displayed on a user interface that is displayed on a touch-sensitive display screen of an electronic device. In one embodiment, the presentation can be a sales presentation, in which the presentation is generated based at least in part on outputs that can represent correlations between the explicit input and at least one of the at least one pre-defined fields which increase the likelihood that the user will purchase or subscribe to the application, customer relationship management system, service, or other product or service demonstrated in the presentation.

While one or more implementations and techniques are described with reference to an embodiment in which a contextual demonstration of a product is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the embodiments described herein may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is a flow chart of an exemplary embodiment of a method for contextual demonstration of an application hosted on a multi-tenant database system;

FIG. 2 is a flow chart of a method for contextual demonstration of an application hosted on a multi-tenant database system in accordance with another embodiment of the present technology;

FIG. 3 is a graphical representation of an exemplary embodiment of the method for demonstration of an application hosted on a multi-tenant database system in accordance with an exemplary embodiment of the present technology;

FIG. 4 illustrates a screenshot of an exemplary user interface of a contextual demonstration of an application in having explicit inputs entered into the pre-defined fields;

FIG. 5 is an illustration of an exemplary embodiment of a presentation generated and displayed by the method for demonstration of an application hosted on a multi-tenant database system in accordance with an exemplary embodiment of the present technology;

FIG. 6 illustrates a block diagram of an exemplary environment wherein an on-demand database service can be used; and

FIG. 7 illustrates a block diagram of an exemplary embodiment of elements of FIG. 6 and various possible interconnections between these elements.

### DETAILED DESCRIPTION

### General Overview

Systems and methods are provided for contextual demonstration of an application hosted on a multi-tenant database system.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing contextual demonstration of an application hosted on a multi-tenant database system will be described with reference to example embodiments. The method for contextual demonstration of an application hosted on a multi-tenant database system as described herein can provide a user with a demonstration of the user-specific benefits of the application based at least in part on explicit inputs entered by the user. Additionally, the method for contextual demonstration of an application hosted on a multi-tenant database system as described herein can provide a user with a demonstration of the application hosted on a multi-tenant database system tailored to the user's potential use of the application. That is, the contextual demonstration of the application can present particular aspects of features of the application which will be of most interest or use to the user based at least in part on explicit inputs entered by the user.

The contextual demonstration of an application hosted on a multi-tenant database system as described herein can be provided to a user through a computer device, an electronic tablet, a smart phone, portable computer, a mobile electronic device or other electronic device. The contextual demonstration of an application hosted on a multi-tenant database system as described herein can also be provided across any platform. For example, by an electronic slideshow attached to an email, by an internet browser, a mobile internet browser, a web app, a phone app, a website, a locally downloaded software application, a trial software program stored on a machine-readable medium, on multiple platforms, or any other platform which is displayable on an electronic device.

In at least one non-limiting example, the contextual demonstration of an application hosted on a multi-tenant database system can be a contextual trial version of the application accessed via a browser application that is displayed on a touch-sensitive display of a mobile communication device. A user can enter explicit user-defined information (for example, explicit inputs) into the a user interface of the contextual demonstration, and the contextual demonstration can generate a tailored presentation of the application based at least in part on those explicit inputs. The contextual demonstration can process the explicit input(s) to generate a presentation containing outputs representing correlations between the user's explicit input(s) and features of the application. For example, the contextual demonstration can process the explicit input(s) to generate a presentation containing images representing the user's explicit input(s) and images relating to features of the application which the contextual demonstration determines the user will most likely utilize. The contextual demonstration can also react to the explicit input(s) by retrieving additional information to include in the presentation based. For example, the contextual demonstration can retrieve implicit user-information (for example, implicit inputs). For example, implicit inputs can include the current location of the user's electronic device, contact data stored on the user's electronic device, past internet browsing history of the user, past social media tool usage, or other implicit inputs which can be retrieved from the electronic device of the user. In another embodiment, the contextual demonstration can retrieve inferential data based upon the explicit input(s). For example, the inferential data can include information which are associated with the explicit input(s) but not directly selected by the user. For example, inferential data can include a contact or business associated with a plurality of explicit inputs. A presentation can then be generated based on the explicit input(s), the implicit input(s), the inferential data, or a combination thereof, thereby further tailoring the contextual demonstration of the application to the user. By providing a tailored demonstration of the application to the user, the user can quickly and effectively realize the benefits of the application specific to the user. This can therefore increase the likelihood that the user will purchase the application.

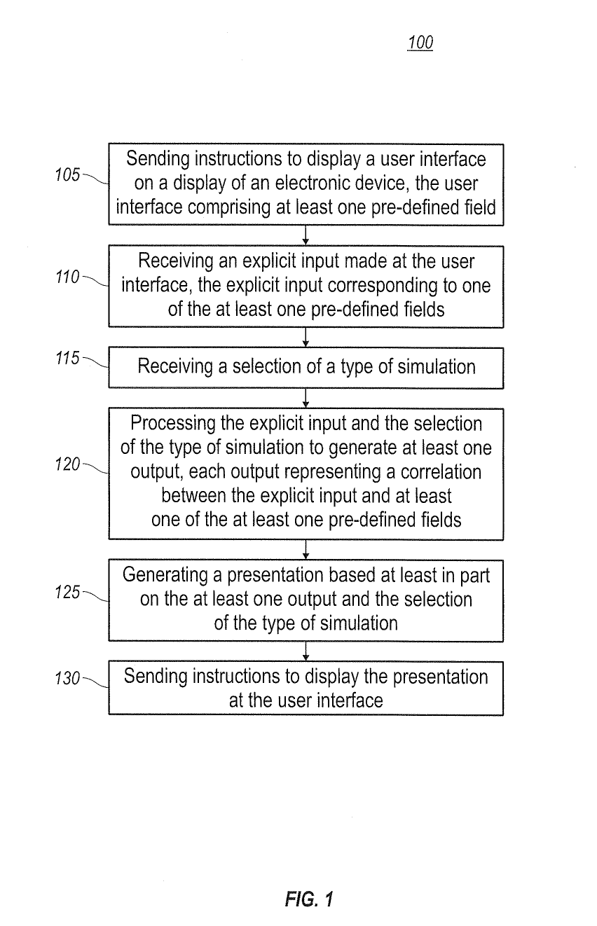

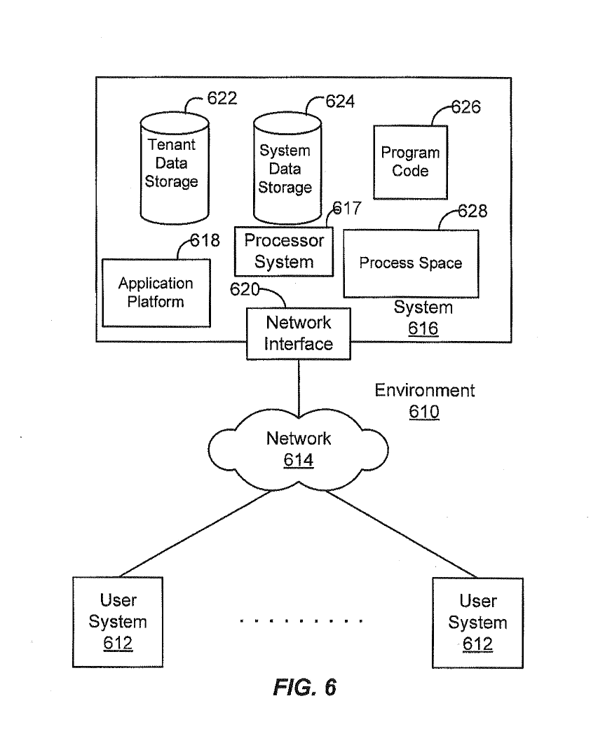

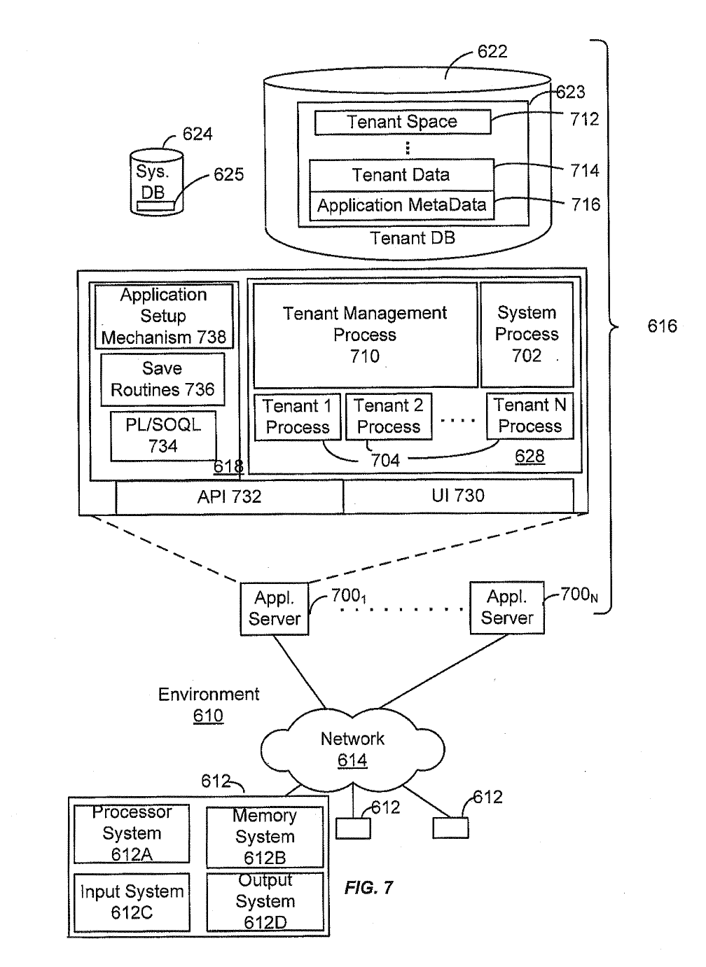

FIG. 1 is a flow chart of an exemplary embodiment of a method 100 for contextual demonstration of an application hosted on a multi-tenant database system. The exemplary method 100 illustrated in FIG. 1 is provided by way of example, as there are a variety of ways to carry out the method. Additionally, while the exemplary method 100 is illustrated with a particular order of steps, those of ordinary skill in the art will appreciate that FIG. 1 is by way of example, and the steps illustrated therein can be executed in any order that accomplishes the technical advantages of the present disclosure described herein and can include fewer or more steps than as illustrated. The method 100 described below can be carried out using an electronic device and communication network shown in FIGS. 6 and 7 by way of example. Each block shown in FIG. 1 represents one or more processes, methods or subroutines, carried out in exemplary method 100.

In FIG. 1, a processor communicatively coupled to the multi-tenant database system can execute instructions that enable a user to access a demonstration of an application hosted on a multi-tenant database system, and the method 100 for contextually demonstrating an application can begin. For example and without limitation, enabling access to the demonstration can include enabling access to the application can be made via a website, a software program stored on a computer-readable medium and run on a processor communicatively coupled to an electronic device, a browser application, or other mechanism that enables a user to access the customer relationship management application. After enabling access to the demonstration, the method 100 can proceed to block 105.

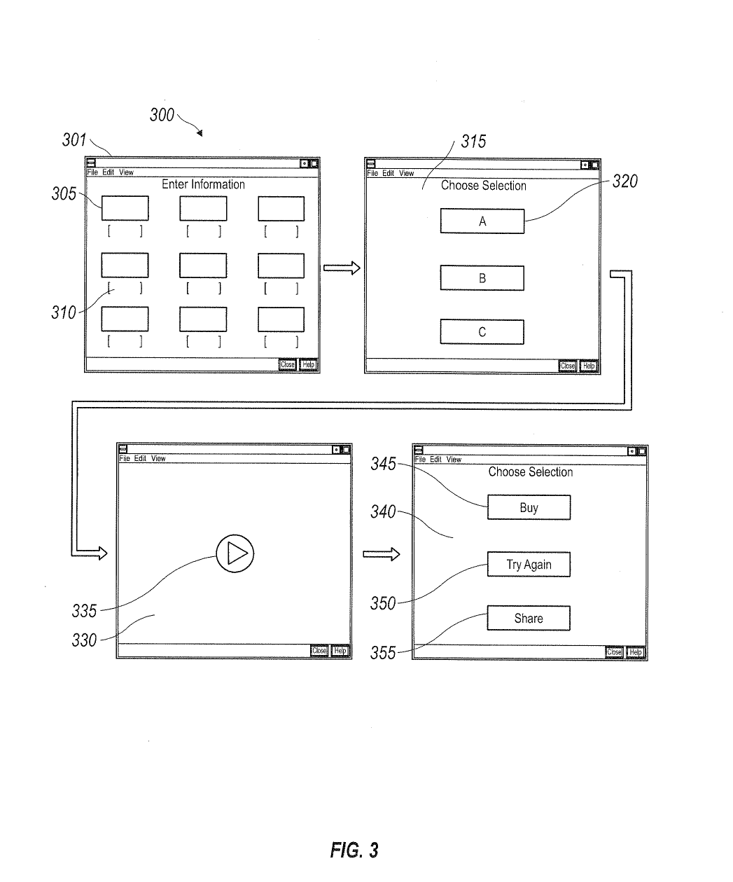

At block 105, the method 100, for example the processor communicatively coupled to the multi-tenant database, can display an exemplary first user interface 301 (shown in FIG. 3) including at least one pre-defined field 305. By way of example and without limitation, the first user interface 301 can be displayed on a display 300 of a smartphone. However, in other embodiments, the first user interface 301 can be displayed on a web browser, the display screen of a desktop computer, the display screen of a laptop computer, the display screen of a tablet, the display screen of a pocket PC, the display screen of a mobile communication device, or the display screen of other electronic devices which can be communicatively coupled to the multi-tenant database system. In at least one embodiment, the at least one pre-defined field 305 can be defined by the application. In other embodiments, the pre-defined fields 305 can be defined by a sales representative who will be delivering the presentation to the user (for example, the potential customer), by the software developer of the application, can be automatically selected by the application from a database of pre-defined fields 305 stored in the multi-tenant database system, or can be pre-defined by any other person or system having access to the contextual demonstration. The at least one pre-defined field 305 displayed in the first user interface 305 can include a user's name, a user's company, a user's coworkers, a current city of the user, a destination of the user, a make and model of a user's car, a user's favorite food, or other information specific to the user. After displaying the exemplary first user interface 300, the method 100 can proceed to block 110.

At block 110, the method 100, for example the processor communicatively coupled to the multi-tenant database, can receive an explicit input 310 (shown in FIG. 3) at the exemplary first user interface 301. For example, the explicit input 310 can be explicitly entered by the user via one or more of the following: a touch-sensitive display screen, a navigation tool, input keys or buttons, voice commands, or other mechanisms for entering inputs into an electronic device having access to the demonstration. For example, in one exemplary embodiment, the explicit input 310 can be detected at an electronic device, and signals corresponding to the explicit 310 can be transmitted to and received by the multi-tenant database hosting the customer relationship management application. The explicit input 310 can correspond to one or more of the pre-defined fields 305 pre-defined. For example and without limitation, the explicit input 310 can include a user's name, a user's company, a user's coworkers, a current city of the user, a destination of the user, a make and model of a user's car, a user's favorite food, or other information specific to the user and identified by a pre-defined field 305 displayed in the user interface. In at least one exemplary embodiment, the user can enter more than one explicit input 310. For example, the user can enter a plurality of explicit inputs 310, and each explicit input 310 can correspond to a pre-defined field 305. In at least one exemplary embodiment, after the explicit input 310 is received by the application (for example, by a processor communicatively coupled to the multi-tenant database), the method 100 can proceed to block 115.

At block 115, the method 100, for example the processor communicatively coupled to the multi-tenant database, can instruct the application to display a second user interface 315 (illustrated in FIG. 3). The second user interface 315 can display at least one user-selectable simulation option 320. Each of the at least one user-selectable simulation options 320 can enable the user to select a type of simulation the user desires to simulate in the demonstration. For example, each of the at least one user-selectable simulation options 320 can correspond to one of a sales simulation, a service simulation, a mobile use simulation, or other simulation. For example, the sales simulation can be a simulation of how the application can be utilized by a person employed in a sales industry. A service simulation can be a simulation of the application can be utilized by a person employed in the service industry. The mobile use simulation can be a simulation of how the application can be used on a mobile device. After the second user interface 315 is displayed to the user, the method 100 can proceed to block 120.

Also at block 115, the method 100, for example the processor communicatively coupled to the multi-tenant database, can receive an input corresponding to a selection of one of the user-selectable simulation options 320 displayed in the second user interface 315. When the explicit input 310 is received at block 110 and when an input corresponding to a selection of user-selectable simulation options 320 is received at block 115, the method 100 can proceed to block 120.

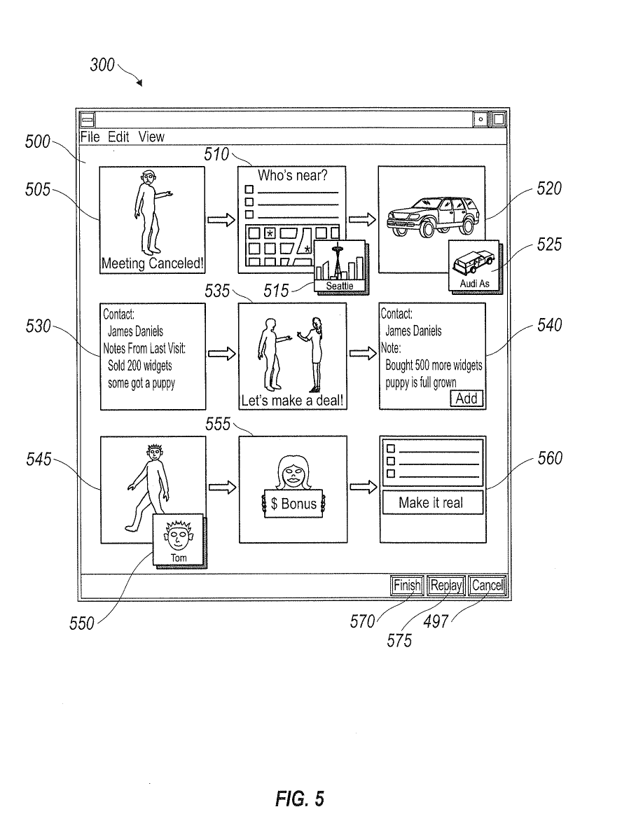

At block 120, the method 100 can process the explicit input 310 and the selected user-selectable simulation option 320 to generate at least one output 505 (shown in FIG. 5). In one exemplary embodiment, a processor communicatively coupled to the multi-tenant database can receive and process the explicit input 310 and the selected user-selectable simulation option 320. In another embodiment, another processor separate from the processor that receives the explicit input 310 and the selected user-selectable simulation option 320 can process the explicit input 310 and the selected user-selectable simulation option 320. In one example, without limitation, the method can generate an output 505 that represents a correlation between the explicit input 310 and one of the at least one pre-defined fields 305 based on the selected user-selectable simulation option 320. In another embodiment, an output 505 can represent a correlation between the explicit input 310 and at least one of the at least one pre-defined fields 305. In still another embodiment, the output 505 can represent a correlation between at least one explicit input 310 and one of the one or more fields 305. In an illustrative non-limiting example, the method 100 can determine that based on an explicit input 310 corresponding to the make and model of a user's car, an explicit input 310 corresponding to the name of the user's boss, and an explicit input 310 corresponding to the current city of the user, the method 100 can generate an output 505 representing the correlation between the three user-defined inputs 310. For example, the generation of the output 505 can be made based on a determination that there is a match between one of the explicit inputs 310 and an output 505 corresponding to a field 305. In at least one embodiment, the output 505 can be stored on storage medium coupled to the multi-tenant database, and when a match is determined between one of the inputs 310 and one of the fields 305, the corresponding output 505 can be retrieved from the storage medium of the multi-tenant database for inclusion into a presentation, as will be discussed below. In a more specific embodiment, the output 505 can be a graphical representation of a match between data, such as client information stored on the multi-tenant database and the explicit input 310 corresponding to the current city the user is in, the name of the user's boss, the make and model of the user's car. For example, the multi-tenant database can include a database of contact information (for example, names, phone numbers, email addresses, specific personal notes associated with the contact information). The database of contact information can be compiled from contact information stored by the user as well as other users in the multi-tenant database. In other words, the database of contact information can be a compilation of contact information stored by a user on the multi-tenant database made available to other user of the multi-tenant database. For example, the match can instruct the application to generate an output 505 that is a graphical representation of contact information of a potential new client who is of interest to the user's boss and is located in the current city of the user. Another output 520 can be generated that is a graphical representation of the make and model of the user's car driving on a street in the current city in which the user is presently located. After at least one output 505, 520 is generated by the method 100, the method 100 can proceed to block 125.

At block 125, the method 100, for example the processor communicatively coupled to the multi-tenant database, can generate a presentation 500 (shown in FIG. 5) of the at least one output 505, 520. In at least one non-limiting example, generating the presentation 500 can include organizing the at least one output 505, 520 in a story line associated with the user. For example, the presentation 500 can be a story line of possible scenarios and outcomes in which the user can contact or engage in a business deal with a potential client as a result of the user's purchase of an interaction with the application hosted on the multi-tenant database system. In other embodiments, the presentation 500 can be a sales presentation, a preview presentation providing the user with a preview of the features of the application or product, a trial simulation of the application, a story-telling presentation, or other presentations which demonstrate features of the presentation that are relevant to the user and which contain contextual information relevant to the user. After the presentation 500 is generated at block 125, the method 100 can proceed to block 130.

At block 130, the method 100 can send instructions to the electronic device of the user to display the presentation 500. For example, the processor communicatively coupled to the multi-tenant database system can send instructions to a processor of the electronic device to display the presentation. In at least one exemplary embodiment, the presentation 500 can be displayed on the display 300 of the user's smartphone. The presentation 500 can be displayed on a web browser, the display screen of a desktop computer, the display screen of a laptop computer, the display screen of a tablet, the display screen of a pocket PC, the display screen of a mobile communication device, or the display screen of other electronic devices which can be communicatively coupled to the multi-tenant database system. With the example described in the previous paragraph, the presentation 500 can be generated to simulate a hypothetical scenario between the user and the potential new client. The presentation 500 can demonstrate to the user that purchasing the application hosted on the multi-tenant database system can lead to a meeting with a potential new client who is of interest to the user's boss. As the potential new client is located in the current city of the user, the presentation can provide an indication to the user that the potential client is accessible for a meeting. Such contextual demonstration of these hypothetical scenarios can assist the user in realizing the benefit and value of purchasing the application being contextually demonstrated. In the exemplary embodiment described above, the presentation can effectively and efficiently demonstrate the particular features of the application which can be relevant to the user's potential use of the application. In at least one embodiment, the presentation can demonstrate the benefits the application can provide to the user in preparing for meetings with customers, informing the user of customer relationships that would otherwise be overlooked by the user, and enhancing employment training for a user whose position relies on the user of a customer relationship management system hosted on the multi-tenant database system.

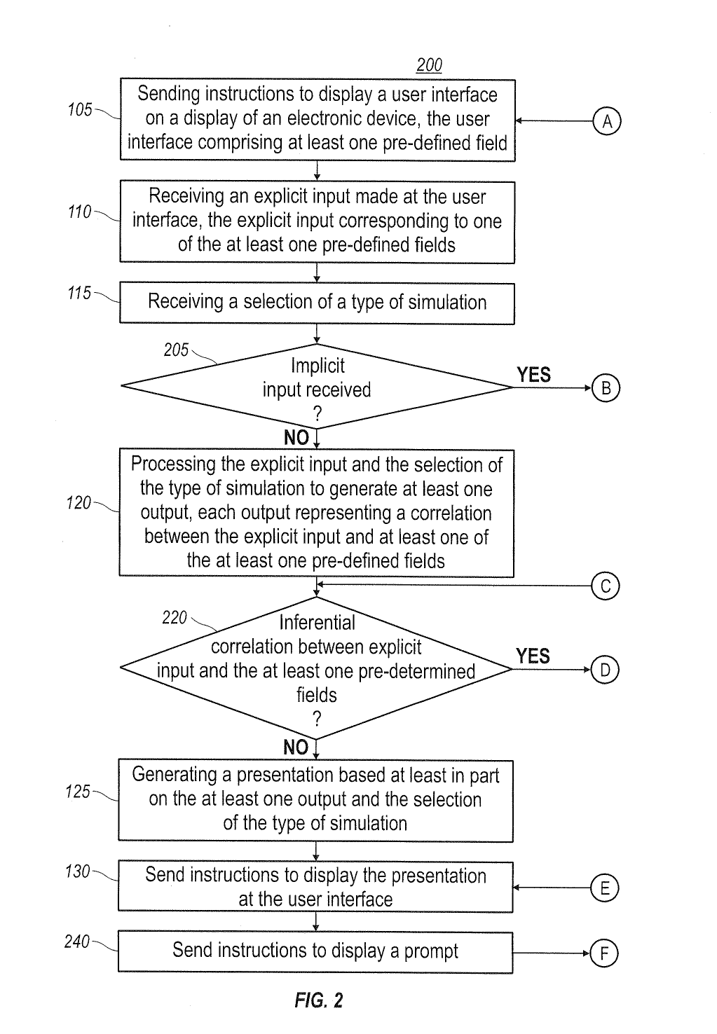

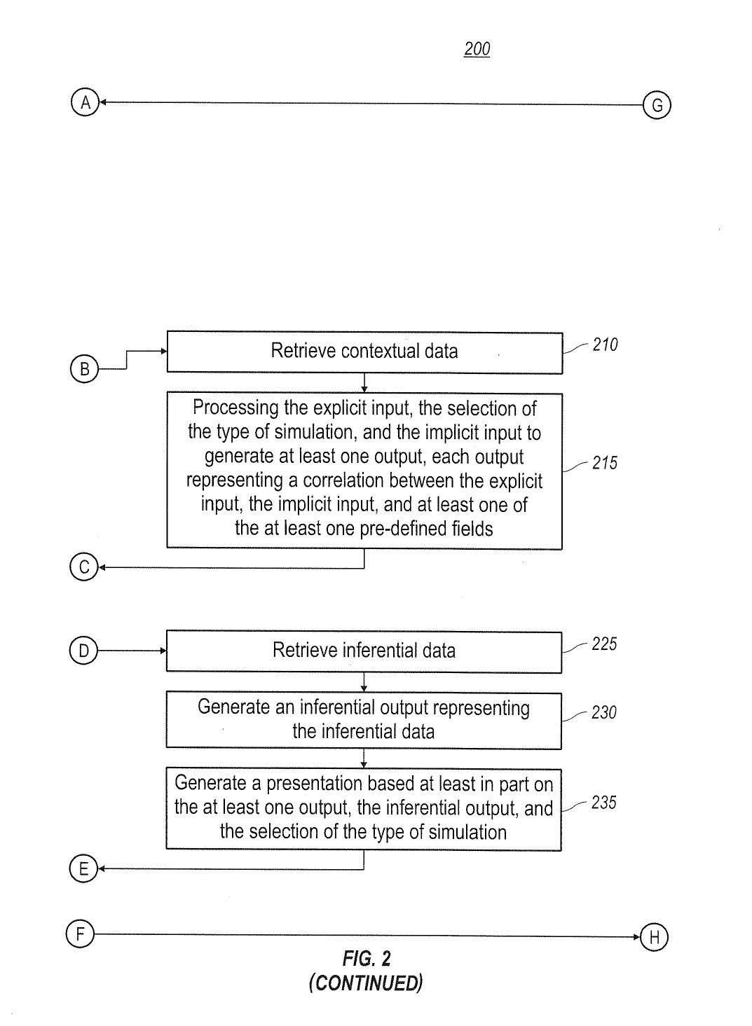

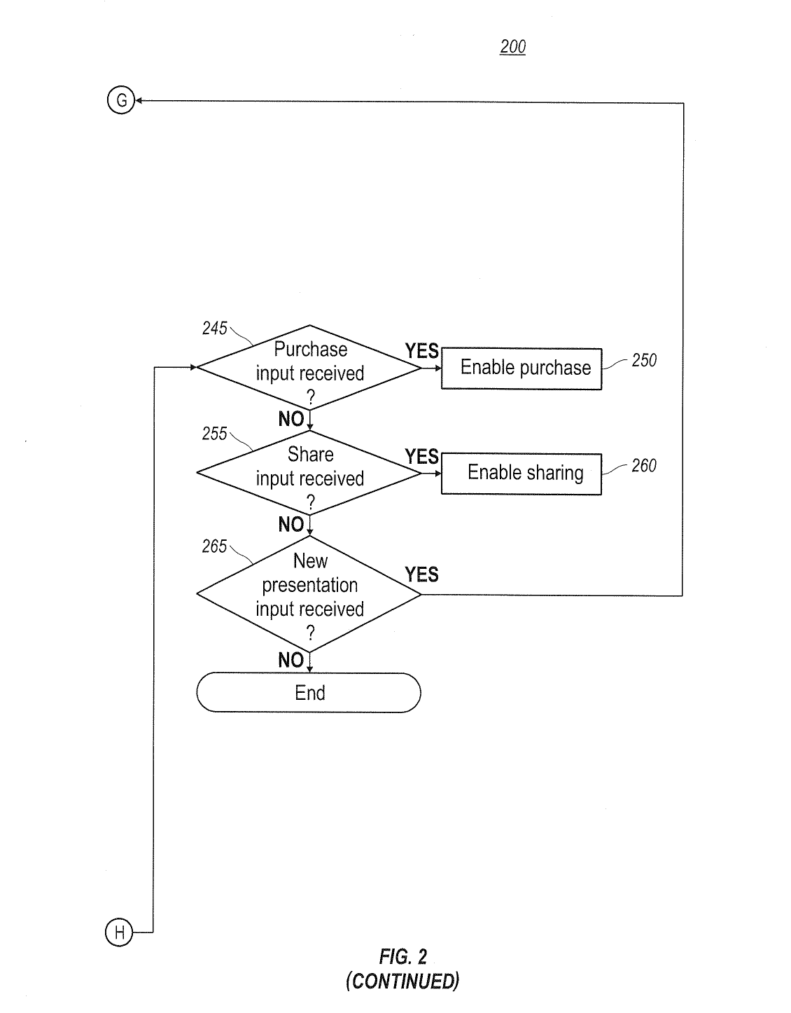

FIG. 2 is a flow chart of another embodiment of a method for providing contextual demonstration of an application hosted on a multi-tenant database system in accordance with the present disclosure. The exemplary method 200 illustrated in FIG. 2 is provided by way of example, as there are a variety of ways to carry out the method. Additionally, while the exemplary method 200 is illustrated with a particular order of steps, those of ordinary skill in the art will appreciate that FIG. 2 is by way of example, and the steps illustrated therein can be executed in any order that accomplishes the technical advantages of the present technology described herein and can include fewer or more steps than as illustrated. The method 200 described below can be carried out using an electronic device and communication network shown in FIGS. 6 and 7 by way of example. Each block shown in FIG. 2 represents one or more processes, methods or subroutines, carried out in exemplary method 200.

The method 200 illustrated in FIG. 2 is similar to method 100 in FIG. 1 but differs from the method 100 illustrated in FIG. 1 in that the method 200 includes the additional steps of determining whether an implicit input has been received (block 205), whether an inferential correlation has been made (block 220), and sending instructions to display a prompt (block 240). These additional steps will be described in further detail below. Method 200 can proceed similarly as described above in relation to FIG. 1 from blocks 105-115. After receiving a selection of a type of simulation at block 115, the method 200 can proceed to block 205.

At block 205, the method 200, for example the processor communicatively coupled to the multi-tenant database, can receive an implicit input from the electronic device on which the user interface 301 is displayed. The implicit input can be received from the user's interactions with other programs stored on his electronic device, information transmitted from other programs stored and running on his electronic device, historical information stored on his electronic device and accessible by the application which will be contextually demonstrated to the user, or other implicit inputs which are received by the application from the user's device but not explicitly or directly inputted by the user. For example, implicit inputs can include the current location of the user's electronic device, contact data stored on the user's electronic device, past internet browsing history of the user, past social media tool usage (for example, Facebook™ usage, Twitter™ usage, Chatter™ usage, Youtube™ usage, or other social media tool usage), or other implicit user information which can be retrieved from the electronic device of the user. If an implicit input is received from the electronic device on which the user interface 301 is displayed, the method 200 can proceed to block 210.

At block 210, the method 200, for example the processor communicatively coupled to the multi-tenant database, can retrieve contextual data based on at least in part on implicit input and the explicit input. For example, in an exemplary non-limiting embodiment, the implicit input received can be a current location of the electronic device on which the user is currently viewing the contextual demonstration and the explicit input can be an automobile industry corresponding to a pre-defined field 305 labeled “Industry.” Based at least in part on these implicit inputs and explicit inputs, the method 200 can retrieve contextual data such as a name of a contact or the name of a business associated with the explicit input 305 of an automobile industry located within a predetermined distance from the implicit input of the current location of the electronic device.

In another embodiment, the implicit input can be a history of past social media tool usage and the explicit input 305 can be a plurality of explicit inputs. For example, the history of past social media tool usage can indicate that the user had been posting reviews of a new gadget his employer sells. The plurality of explicit inputs 310 can include a type of phone the user uses that is entered in a “Kind of Phone” pre-defined field 305 and the name of the user's co-worker entered in a “Co-worker” pre-defined field 305. In at least one embodiment, the contextual data corresponding to the implicit input and explicit input 305 retrieved can a posted response to the user's posted review written by the co-worker explicit inputted by the user. In any of the embodiments described herein, the contextual data can be retrieved from a database communicatively coupled to the multi-tenant database system, a third-party database, a third-party resource, the internet, a social networking sphere, a crowdsourcing resource, or other resource from which the application can retrieve data corresponding to implicit inputs and explicit inputs received from the electronic device of the user. After contextual data is retrieved, the method 200 can proceed to block 215.

At block 215, the method 200 can process the explicit input, the selection of the type of simulation and the implicit input (including the retrieved contextual data), to generate at least one output. Each output can represent a correlation between the explicit input, the implicit input, and at least one of the at least one pre-defined fields. For example, in the embodiment in which the implicit input is the current location of the electronic device on which the user is currently viewing the contextual demonstration and the explicit input can be an automobile industry corresponding to a pre-defined field 305 labeled “Industry,” the output generated can be an image of an automobile manufacturing corporate office located within a close proximity to the current location of the electronic device. Such an output can demonstrate a business searching feature of the application being contextually demonstrated.

In another non-limiting embodiment in which the implicit input is a history of past social media tool usage indicating the user had posted review of a new gadget his employer sells and in which the explicit inputs include a type of phone the user uses and the name of the user's co-worker, the generated output can be a movie clip of the type of phone the user uses receiving a newsfeed message from another service offered by the manufacturer of the application. The newsfeed message can be a response to the user's posted review posted and written by his co-worker. Such an output can demonstrate an interoperability feature of the application with other applications offered by the same manufacturer. Although two specific examples of implicit inputs, explicit inputs, and outputs which can be generated therefrom have been described, those skilled in the art will appreciate that these examples are non-limiting and other implicit inputs, explicit inputs, and outputs which can be generated therefrom are considered within the scope of the present disclosure.

Additionally, in at least one embodiment, processing the explicit input, the selection of the type of simulation, and the implicit input can include determining an inferential correlation between the explicit input and the at least one-predetermined fields, for example, as in block 220, as will be described in detail below.

While the previous paragraphs discuss an embodiment where implicit inputs are received, there can be embodiments where no implicit inputs can be received. If no implicit input is received at block 205, the method 200 can proceed to block 120 to process the explicit input and the selection of the type of simulation to generate at least one output, similar to the block 120 described in relation to FIG. 1.

In at least one embodiment, processing the explicit input and the selection of the type of simulation, can further include determining if there is an inferential correlation between the explicit input 310 and the at least one pre-defined field 305, for example, at block 220. In at least one embodiment, the processor communicatively coupled to the multi-tenant database, can determine if there is an inferential correlation between the explicit input 310 and the at least one pre-defined field 305. An inferential correlation can include, but is not limited to, determining that there are common elements shared between but the inputs explicitly entered by the user. For example, in an embodiment where the explicit inputs include the current city in which the user is located, the name of the user's company, the name of the user's co-worker, and a destination city, an inferential correlation can be made therebetween that a contact is associated with the user's company, the user's co-worker, and the destination city. In another embodiment, the inferential correlation can be made that a news article was published in the destination city mentioning the name of the user's company and the user's co-worker. Although two specific examples of inferential correlations have been described, those skilled in the art will appreciate that these examples are non-limiting and other inferential correlations are considered within the scope of the present disclosure. Additionally, while the previous examples consider drawing inferential correlations between explicit inputs and at least one pre-defined field, those skilled in the art will appreciate that inferential correlations can be made between explicit inputs, implicit inputs, and any of the at least one pre-defined fields. If inferential correlations are made at block 220, the method 200 can proceed to block 225.

At block 225, inferential data can be retrieved, for example, by the processor communicatively coupled to the multi-tenant database system. The inferential data can correspond to the inferential correlation determined at block 220. In at least one non-limiting embodiment, the inferential data can include at least one of a contact and a business having at least one explicit input in common. In another one non-limiting embodiment, the inferential data can include contact data associated with but not directly corresponding to the explicit input and at least one of the at least one pre-defined fields 305. For example, in the embodiment described in the previous paragraph where the explicit inputs include the current city in which the user is located, the name of the user's company, the name of the user's co-worker, and a destination city, the inferential correlation made therebetween is that a contact is associated with the user's company, the user's co-worker, and the destination city. In response to this correlation, the inferential data retrieved can be contact data corresponding to the contact associated with the user's company, the user's co-worker, and the destination city. For example, the contact data can include a name, an address, an occupation, a phone number, an email address, a photo, or other data associated with the contact. In another embodiment, where the inferential correlation made is that a news article was published in the destination city mentioning the name of the user's company and the user's co-worker, the inferential data retrieved can be the text of the news article. Although three specific examples of inferential data have been described, those skilled in the art will appreciate that these examples are non-limiting and other inferential data which can correspond to inferential correlations made between explicit inputs and pre-defined fields are considered within the scope of the present disclosure. Additionally, while the previous examples describe inferential data corresponding to inferential correlations between explicit inputs and at least one pre-defined field, those skilled in the art will appreciate that inferential data can correspond to inferential correlations can be made between explicit inputs, implicit inputs, and any of the at least one pre-defined fields. Further still, those of ordinary skill in the art will appreciate that the inferential data can be retrieved from any source. For example, the inferential data can be retrieved from a storage medium of the user's device, a storage medium coupled to the user's device, the internet, a database of the multi-tenant database system, a third-party database coupled to the multi-tenant database system, a remote database communicatively coupled to the multi-tenant database system, a social networking site, a crowdsourcing resource, or any other resource from which information and data can be retrieved. If inferential data is retrieved, the method 200 can proceed to block 230.

At block 230, the method 200 can generate an inferential output representing the inferential data. For example, the processor communicatively coupled to the multi-tenant database system can generate the inferential output. Considering the examples described in the previous embodiments, in the example, where the inferential data is contact data corresponding to the contact associated with the user's company, the user's co-worker, and the destination city, the inferential output generated can be an animation derived from a photo of the user and a photo of the contact demonstrating that the user and the contact are attending a meeting. In another example where the inferential data retrieved can be the text of the news article, the inferential output can be an animation of the user reading a newspaper having the text of the article. In other embodiments, the generated output can be images, video, animations, sound clips, moving text, or other outputs representing the inferential data. While the embodiments described herein describe one inferential output, those skilled in the art will appreciate that more than one inferential output can be generated. After the inferential output is generated, the method 200 can proceed to block 235.

At block 235, the method 200 can generate a presentation based at least in part on the at least one output, the inferential output, and the selection of the type of simulation. The presentation can be generated similarly as described in relation to FIG. 1. After the presentation is generated, the method 200 can proceed to block 130.

Similarly, if no inferential correlations are determined at block 230, the method 200 can proceed to block 125. At block 125, the method 200 can generate a presentation based at least in part on the at least one output and the selection of the type of simulation as similarly described in relation to FIG. 1. After the presentation is generated, the method 200 can proceed to block 130.

At block 130, the method 200 can send instructions to display the presentation generated at either block 235 or block 125, depending on whether inferential correlations are determined, at the user interface displayed on the user's device. For example, the processor communicatively coupled to the multi-tenant database system can send instructions to the user's mobile device to display the presentation at the user interface, similarly as described in relation to FIG. 1. After the instructions to display the presentation are sent to the user's device, the method 200 can proceed to block 240.

At block 240, the method 200 can send instructions to display a prompt 340 (shown in FIG. 3). For example, a processor communicatively coupled to the multi-tenant database can send instructions to the user's electronic device to display a prompt 340 on the display screen of the electronic device. In at least one example, the prompt 340 can be displayed at the conclusion of the presentation 500. The prompt 340 can request additional information from the user regarding the user's reaction to the presentation 500. For example, the prompt 340 can display user-selectable options 345, 350, 355. The user-selectable options 345, 350, 355 can include a share option 355, a purchase option 345, and a new presentation option 350. After the prompt 340 is displayed to the user, the method 200 can proceed to block 245.

At block 245, the method 200 can receive an input corresponding to the user-selectable options 345, 350, 355 included in the prompt 340. For example, the input can be a selection of one of the user-selectable options 345, 350, 355. In at least one example, if a user input is received corresponding to a purchase input, at block 245, the method can proceed to block 250. At block 250, the method 200 can enable the user to purchase the customer relationship management application. For example, the method 200 can enable the user to enter payment information to purchase the client relationship management application. In another non-limiting example, the method 200 can enable the user to payment information, such as credit card information, bank account information, or other payment information to purchase the client relationship application. If a purchase input is not received, the method 200 can proceed to block 255 or can end the presentation.

At block 255, the method 200 can determine if a share input has been received. If a share input has been received, the method 200 can proceed to block 260. At block 260, the method 200 can enable the user to share the presentation. For example, in at least one implementation, the method 200 can enable the user to email the presentation to a co-worker and/or his boss, to post the presentation on a social media website, to email a link to the presentation to another person, to send a multimedia message containing the presentation to another mobile communication device, or to otherwise transmit the presentation, a link to the presentation, or the directory location of the presentation to another person. If a share input is not received, the method 200 can proceed to block 265 or can end the presentation.

At block 265, the method 200 can determine if a new presentation input has been received. In at least one non-limiting example, a new presentation input can be a request for a new presentation. The new presentation can be a second presentation different from the presentation previously displayed to the user. In another embodiment, the request for a new presentation can be a request to enter new inputs at the user interface to generate an updated presentation from the presentation previously displayed to the user. In FIG. 2, a user input is received at block 265 to generate a new presentation based on new user inputs entered at the user interface. In response to such an input, the method 200 can return to block 105, and the method proceeds as previously discussed to present another presentation. If however, no inputs are received corresponding to the user-selectable options presented in the prompt, the method 200 can end.

FIG. 3 is a graphical representation of another exemplary method for contextual demonstration of an application hosted on a multi-tenant database system. In one non-limiting example, the method for contextual demonstration of an application hosted on a multi-tenant database system can be in the form of a machine-readable medium storing one or more sequences of instructions for providing a contextual demonstration of an application hosted on a multi-tenant database system, which instructions, when executed by one or more processors, cause the one or more processors to display a first user interface 301 through which a user can enter inputs to be processed by a processor communicatively coupled to the multi-tenant database system. For example, as illustrated in FIG. 3, the first user interface 301 is displayed on a display screen 300 of an electronic device. In FIG. 3, the first user interface 301 includes a plurality of pre-defined fields 305. The pre-defined fields 305 can be categories that are pre-defined by the application being contextually demonstrated. However, in other embodiments, the pre-defined fields can be pre-defined by a sales representative who will be delivering the presentation to the user (for example, the potential customer), by the software developer of the application, or can be automatically selected by the application from a database of pre-defined fields 305 stored in the multi-tenant database system. In at least one example, the pre-defined fields 305 can include user's name, the user's company, the user's industry, the name of the user's boss, the name of the user's coworkers, the city in which the user's company is in, the type of phone the user uses, the type of car the user drives, the user's favorite drink, or other user-specific information.

Each user-definable input box 310 can be associated with at least one of the pre-defined fields 305. In another example, each user-definable input box 310 can be associated with one of the pre-defined field 305. Each user-definable input box 310 can be positioned proximate to the associated pre-defined field 305. In one example, the user-definable input box 310 can be positioned below the corresponding associated field 305. FIG. 3 illustrates exemplary user-definable input boxes 310. Specifically, in FIG. 3, the user-definable input box 310 is a text entry box through which a user can type-in a user-defined corresponding to the associated pre-defined field 305. In one or more embodiments, the user-definable input box 310 can be a pull-down menu, a pop-up menu of user-selectable icons, a drag and drop box by which at least one icon is displayed and can be dragged and dropped in the field 305, or other user-definable input entry mechanism by which an input can be user-defined. For example, in one embodiment, the user can enter the user's name, the user's company, the user's industry, the name of the user's boss, the name of the user's coworkers, the city in which the user's company is located, the type of phone the user uses, the type of car the user drives, the user's favorite drink, or other user-specific information in the corresponding user-definable input boxes 310.

When the user-definable input boxes 310 have been defined for at least one pre-defined field 305, a second user interface 315 can be presented to the user. Those of ordinary skill in the art will appreciate that at least one input or entry for a pre-defined input box 310 is required to proceed to the next step for the demonstration. Returning to FIG. 3, the second user interface 315 can provide the user with another set of user-selectable simulation options 320. The user-selectable simulation options 320 can be a selection of a type of simulation. For example, the user-selectable simulation options 320 can include a sales simulation, a service simulation, a mobile use simulation, a simulation of other features and uses of the application being demonstrated, or other simulations. For example, the sales simulation can be a simulation of how the application can be utilized by a person employed in a sales industry. A service simulation can be a simulation of the application can be utilized by a person employed in the service industry. The mobile use simulation can be a simulation of how the application can be used on a mobile device. However, other user-selectable simulation options 320 can be included. The user-selectable simulation options 320 can enable the user to select a type of simulation 320 to be illustrated in the presentation.

In response to the user's selection of one of the user-selectable simulation options 320, the customer relationship management system can generate a presentation 330 to be displayed to the user. In FIG. 3, the presentation 330 can be a video 335. For example, the presentation 330 can be an animated movie. In other embodiments, the presentation 330 can be a plurality of story boards, a comic strip, an audio file, a slideshow of drawings, a multimedia presentation, or other presentation that illustrates the simulated scenario generated by the contextual customizable customer relationship management system based on the inputs entered by the user at the first user interface 301.

In at least one embodiment, a prompt 330 can be displayed. In FIG. 3, the prompt 330 can be displayed at the conclusion of the presentation video 335. In FIG. 3, the prompt 330 displays another set of user-selectable options 345, 350, 355. In one embodiment, the user selectable options can include a purchase option 345 to enable the user to purchase the customer relationship management application.

The user-selectable options 345, 350, 355 can also include a try again option 350 to enable a generation of another presentation 330 based on the same inputs entered at the first user interface 301 and the same selection of the simulation user-selectable option 320 of the second user interface 315. In another embodiment, the try again option 350 can be a modify option which can enable a generation of another presentation 330 based on the same user-defined inputs entered at the first user interface 301 but a different selection of the simulation user-selectable option 320 of the second user interface 315. In yet another embodiment, the modify option can enable a generation of another presentation 330 based on a new set of user-defined inputs entered by the user at the first user interface 301. For example, in such an embodiment, selection of the try again option 350 can re-display the first user interface 301, thereby enabling the user to enter a different set of user-defined inputs from which the contextual customizable customer relationships management system can generate a presentation 330.

The user-selectable options 345, 350, 355 can also include a share option 355. The share option 355 can enable the user to share or distribute the presentation to another person. For example, the share option 355 can enable the user to: email the presentation to another person; post the presentation, a hyperlink to the presentation, or posting the location of the presentation on a social media network; forward the presentation as a multimedia message on a mobile communication device; or other mechanism for forwarding or sharing the presentation to one or more people. In at least one embodiment, if the share option 355 is selected, and the presentation 500 is delivered to another person, the presentation 500 can automatically be modified or updated based on the recipient of the presentation. For example, the presentation 500 can demonstrate the features and benefits of the application that are determined to be relevant to the recipient of the presentation, which can be different from the features and benefits demonstrated in the presentation generated for the sender. If no selection is made at the prompt 340, the presentation 330 can end. In at least one implementation, no selection at the prompt 340 can signify the end of a user's trial period for using the contextual customizable customer relationship management system.

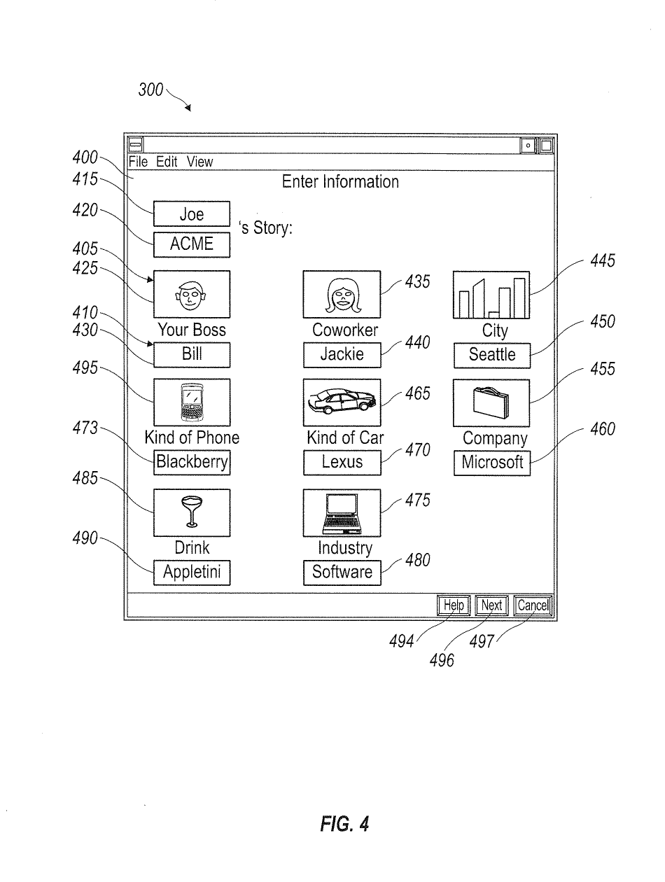

FIG. 4 illustrates a screenshot of an example user interface 400 of a contextual demonstration of an application hosted on a multi-tenant database system. The user interface 400 illustrated in FIG. 4 is similar to the user interface 300 illustrated in FIG. 3, except that the user interface 400 in FIG. 4 provides detailed examples of pre-defined fields 405 that can be displayed on the user interface 400. For example, and without limitation, the user interface 400 illustrated in FIG. 4 is the first user interface 400 presented to a user when initiating the contextual demonstration of the application hosted on the multi-tenant database system. The user interface 400 includes at least one pre-defined field 405 pre-defined by the application. In FIG. 4, the user interface 400 includes eight fields 405; however, those of ordinary skill in the art will appreciate that fewer or more fields 405 can be included than as illustrated. In FIG. 4, the fields 405 can include a Boss field 425, a Coworker field 435, a City field 445, a Kind of Phone field 495, a Kind of Car field 465, a Company field 455, a Drink field 485, and an Industry field 475. Those of ordinary skill in the art will appreciate that other types of fields 405 can be implemented in place of or in addition to the fields 405 illustrated in FIG. 4. For example, other fields 405 can include, Favorite Restaurant, Scheduled Meetings, College, Favorite Color, Product Line, Company Size, or any other field 405 which solicits information from the user which can be utilized by the contextual demonstration to generate a presentation.

Below each field 405 is a corresponding user-definable input box 410. The user-definable input box 410 enables a user to explicitly input information corresponding to the associated field 405. As described above, the user-definable input box 410 can be located in a position other than below the corresponding field 405. Additionally, the user-definable input box 410 can be a pull-down menu, a pop-up menu, or other representation that enables a user to enter inputs corresponding to the field 405. Also illustrated in FIG. 4, the user interface 400 can include a Name field 415 and a User's Company 420 field, thereby further personalizing and customizing the presentation of customer relationship management to the user. As previously discussed, the customer relationship management application requires at least one input be received corresponding for or at least one user-definable input box 410.

FIG. 4 further also illustrates exemplary explicit inputs entered by a user. In the non-limiting example illustrated in FIG. 4, the user has entered the name Joe in the Name field 415 and the user's company name Acme in the Company field 420. In the Boss field 425, the user has entered the name Bill in the corresponding user-definable input box 430. In the coworker field 435, the user has entered a coworker's name Jackie in the corresponding user-definable input box 440. In the city field 44, the user has entered the name of the city in the user-definable input box 450. For example, in FIG. 4, the user has entered the name of the city, Seattle, where a desired customer's business is located. In another embodiment, the user can enter the name of his current city in the user-definable input box 450. In yet another embodiment, the customer relationship management system can determine the current city of the user, without the user's input. For example, the contextual demonstration can determine the current city of the user by detecting positional data of a mobile device that the user is utilizing to access the contextual customizable customer relationship management system. The positional data can be detected using a GPS device or other position sensor. In such an example, the customer relationship management application can automatically enter an input for the current city field 445; however, those of skill in the art will appreciate that the customer relationship management application can enable the user to edit the field (for example, the city field 445) in the event an input is automatically entered for a field 445.

In the Kind of Phone field 495, the user has entered Blackberry® in the corresponding user-definable input box 473, to indicate the kind of phone that the user uses. In the Kind of Car field 465, the user has entered Lexus® in the corresponding user-definable input box 470, to indicate the kind of car the user's boss drives. In the Company field 455, the user has entered the name Microsoft® in the corresponding user-definable input box 460, to indicate the company where a user's desired customer works. In the Kind of Drink field 485, the user has entered Appletini in the corresponding user-definable input box 490, to indicate the user's preferred drink. In the Industry field 475, the user has entered Software in the corresponding user-definable input box 480, to indicate the industry from which the user would like to engage a customer. Again, while FIG. 4 illustrates specific fields and specific user-defined inputs entered by the user, those of ordinary skill in the art will appreciate that fewer or more fields can be included than as shown in FIG. 4. Also, other fields can be pre-defined and displayed on the user-interface in place of or in addition to the fields illustrated in FIG. 4. Additionally, fewer or more user-defined inputs can be entered by the user than as illustrated in FIG. 4. The fields are provided to solicit information from a user. The solicited information can provide information to which the contextual demonstration can utilize to tailor and customize the presentation of the application to demonstrate the features of the application which would be most relevant and beneficial to the user.

After the user has entered at least one user-defined input for at least one field displayed in the user interface, a second user interface 315 (shown in FIG. 3) can be presented to the user. The second user interface 315 can prompt the user to select a type of simulation the user would like to generate in the presentation. The types of simulations can be presented as user-selectable buttons 320, each corresponding to one type of simulation. For example, user-selectable simulation “A” can represent a sales simulation (for example, simulating a potential sale to a customer); user-selection simulation “B” can represent an internal company meeting simulation (for example, simulating a meeting between the user and his boss); user-selection simulation “C” can represent a service simulation, simulating the user providing a service to a customer or client. In the non-limiting example, in FIG. 4, the user has selected user-selectable simulation “B” to simulate a hypothetical meeting between the user and his boss.

The customer relationship management system can process the explicit inputs 410 illustrated in FIG. 4 to generate at least one output. Each output can represent a correlation between at least one of the explicit inputs 410 and at least one of the at least one pre-defined fields 405. In at least one example, the system can also generate an output representing a correlation between the explicit input(s), the one or more at least one pre-defined fields, and the selected user-selectable simulation option, as illustrated in FIG. 3. The outputs representing these correlations can include movie scenes, animated scenes, illustrated scenarios, pop-up information, text, or other representations presented in a presentation to be displayed at a display of a device the user is utilizing to access the contextual demonstration of the application hosted on the multi-tenant database system.

FIG. 4 also illustrates that in at least one exemplary embodiment, a plurality of user-selectable buttons 494, 496, 497 can be optionally included in the user interface 400. For example, in FIG. 4, a Help button 494, a Next button 496, and a Cancel button 497 can be included. The Help button 494 can enable access to a help guide. For example, selection of the Help button 494 can send instructions to the multi-tenant database to display a help guide in a pop-up window, launch a Web browser that links the user to a website hosting the help guide, or other display of a help guide. The Next button 496 enables the user to confirm that entries or inputs have been provided in the at least one field 405. Selection of the Next button 496 can also send confirmation to the multi-tenant database to begin generating outcomes based on the user-defined inputs. The Cancel button 497 can enable the user to cancel or exit the customer relationship management application. Those of ordinary skill in the art will appreciate that fewer or more user-selectable buttons 494, 496, 497 can be included in the user interface 400 and other types of user-selectable buttons 494, 496, 497 can be included than as illustrated in FIG. 4.

In at least one non-limiting example embodiment illustrated in FIG. 5, the contextual demonstration of the application hosted on a multi-tenant database system can generate a presentation 500 of the at least one output based at least in part on the explicit inputs entered by the user at the user interface and based on the user's selection of a user-selectable simulation option. In FIG. 5, a plurality of outputs 505, 510, 520, 530, 535, 540, 545, 555, 560 are generated and organized into a presentation 500. The presentation 500 a can be a plurality of story boards, a comic strip, an audio file, a slideshow of drawings, a multimedia presentation, or other presentation that illustrates the simulated scenario generated by the contextual customizable customer relationship management system based on the inputs entered by the user at the user interface 400.

In the specific example illustrated in FIG. 5, the presentation 500 is a storyboard illustration of outputs generated based at least in part on the explicit inputs 410 and the pre-defined fields 405 illustrated in FIG. 4 and based on a selection of a mobile use type simulation. That is, FIG. 5 illustrates a presentation 500 demonstrating how the user might user the application on a mobile device and demonstrating benefits of the application that might be relevant to the user. For example, the particular presentation 500 in FIG. 5 includes a plurality of scenes 505, 510, 515, 520, 525, 530, 535, 540, 545, 555, 565. As shown in FIG. 5, the explicit inputs 410 defined by the user in user interface 400 can be graphically represented in the presentation. For example, the explicit inputs 410 can be graphically represented as a floating icon 515 (as will be described later), a pop-up icon, a thumbnail image, or other graphical representation. Returning to the specific scenes 505, 510, 515, 520, 525, 530, 535, 540, 545, 555, 565 of the presentation 500 represented in FIG. 5. Scene 505 illustrates a scenario where the user was supposed to have a meeting with his boss, but the meeting was canceled. Specifically, scene 505 depicts an animation of the user walking away from a canceled meeting. Scene 510 is presented to show that the meeting takes place in Seattle (which has represented by a floating icon 515 or other similar representation to indicate that Seattle was an explicit input 410). Scene 510 also shows that the user in the hypothetical scenes of the presentation 500 has access to the application hosted on the multi-database system via a mobile device. For example, scene 510 illustrates a map of the user's specific location in Seattle and above the map is a list of people who are near the user's location. Scene 510 demonstrates a mobile feature of the application hosted on the multi-database system. Scene 510 demonstrates that since the user can access the application via his mobile device, the application can automatically generate a list of nearby contacts who may be in vicinity of the location where the user and his boss were to meet. Scene 510 also illustrates that a nearby contact who is available for a meeting has been contacted to meet with the user at the nearby contact's destination. For example, the customer relationship management system can generate a list of contacts who are located within a predetermined distance from the user's current location. For example, the predetermined distance can be use-defined or can be a default distance set by the multi-tenant database. In at least one example, the predetermined distance can be with a five mile radius, within a three mile radius, within a ten mile radius, within a five minute walk, within a ten minute drive, thirty minutes away from, or other predetermined distance from the user's current location.

Scene 520 shows an animation of the user driving his car (which can been highlighted with a floating icon 525 or other similar representation to indicate that the user's car is an Audi As). While floating icon 525 identifies a car that was not entered in the user interface 400, the car can be selected from explicit previously stored in the multi-tenant database system by the user from a previous presentation. In other embodiments, the floating icon 525 can be retrieved as contextual data or inferential data, as described above in relation to FIG. 2. Scene 520 further illustrates that the user is driving to the nearby contact's destination.

Scene 530 demonstrates another feature of the application which has been determined as being relevant to the user based at least in part on the explicit inputs 410 entered by the user at user interface 400. In FIG. 5, scene 530 demonstrates a notepad feature of the application. Specifically, scene 530 in FIG. 5 provides an animation of the user updating a notepad stored on the multi-tenant database system with notes associated with the contact whom he is going to meet. In another example, if the contact is a new contact or a potential contact for the user, the displayed notes can be another person's notes that have been stored and shared in the multi-tenant database.

Scene 535 illustrates an animation of a hypothetical meeting between the user and the potential client in which the user utilizes his notes retrieved from the multi-tenant database. Also illustrated in scene 535 is the result (e.g., making a deal) of the hypothetical meeting illustrated in scene 530.

Scene 540 illustrates that based on the result illustrated in scene 535, the user has updated his list of contacts to include the information regarding the deal made in scene 535. Specifically, scene 540 is an animation of the user utilizing the notes feature of the application to update his notes regarding the contact.

Scene 545 illustrates an animation of the user's manager speaking with the user. For example, scene 545 illustrates that the user's manager has learned of the user's sales deal and has congratulated him. A floating icon 550 overlays a portion of scene 545 to indicate that the user's manager is named Tom. While Tom was an input entered by the user in the user interface 400, the contextual demonstration of the application hosted on a multi-tenant database system can be enabled to retrieve additional information from the multi-tenant database that are correlated to the inputs 410 entered by the user in the user interface 400.

The presentation 500 can continue to scene 555 which illustrates the result of the scene 545. That is, scene 555 illustrates the outcome of the user's manager learning of the deal he completed in scene 535. Specifically, scene 555 presents an animation of the user being rewarded with a bonus check.

In scene 560, a summary of the outputs 505, 510, 520, 530, 535, 540, 550, 555, 560 is presented. Specifically, in FIG. 5, scene 560 can present a list of the features and benefits of the application that the contextual demonstration determined as being relevant to the user based at least in part on the explicit inputs 410 entered by the user and the type of simulation selected by the user. Thus, the presentation 500 provides the user with a hypothetical story of the user utilizing the application hosted on the multi-tenant database, where the hypothetical story highlights and emphasizes the features and benefits of the application determined relevant to the user based at least in part on the explicit inputs 410 entered by the user at the user interface 400 and the type of simulation selected by the user.

Also illustrated embodiment in FIG. 5 are a plurality of user-selectable buttons 570, 575, 397 which can be optionally included with the presentation 500. Specifically, FIG. 5 illustrates a Replay button 575, a Cancel button 397, and a Finish button 570. The Replay button 575 can enable the user to select the Replay button 575 to replay the presentation 500. The Cancel button 397 can enable the user to cancel the presentation 500 or exit the customer relationship management application. The Finish button 570 can be selected by the user to enable the display of a prompt 240 (illustrated in FIG. 2). The prompt 240 can include user-selectable options that enable the user to: purchase 245 the contextual customizable customer relationship management program; generate 250 a new presentation; or share 255 the presentation 500 with others, as described above. Those of ordinary skill in the art will appreciate that fewer or more user-selectable buttons 570, 575, 397 can be included in the presentation 500 and other types of user-selectable buttons 570, 575, 397 can be included than as illustrated in FIG. 5.

While FIG. 5 illustrates a particular sequence and selection of outputs 505, 510, 515, 520, 525, 540, 545, 555, 560 those of ordinary skill in the art will appreciate that other outputs can be presented to the user in place of or in addition to the outputs illustrated in FIG. 5. Additionally, fewer or more outputs can be presented to the user than as illustrated in FIG. 5.

Those of ordinary skill in the art will appreciate that in other embodiments, the contextual demonstration of an application hosted on a multi-tenant database can enable the use to prioritize which pre-defined fields are important, either by assigning a ranking to the pre-fields, re-organizing the pre-defined fields visually on the user interface, applying stars to the pre-defined fields, highlighting important pre-defined fields, or otherwise providing an indication of the importance of a pre-defined field as compared to another pre-defined field.

The embodiments of the contextual demonstration of an application hosted on a multi-tenant database system described and illustrated herein are provided by way of example and are not limiting on the scope of the present technology. For example, the present disclosure is not limited to contextual demonstration of applications hosted on multi-tenant databases but can also include contextual demonstration of other applications, software programs, web applications, products, services, or any other purchasable item. Those of ordinary skill in the art will appreciate that the present technology pertains to a contextual demonstration of an application hosted on a multi-tenant database system. The contextual demonstration of an application hosted on a multi-tenant database system as described herein provides a contextual customized presentation to the user to demonstrate how the application can benefit the specific user based at least in part on user-provided information. That is, the contextual demonstration described herein generates user-specific presentations of the application that highlight the features and benefits of the application that increase the likelihood that the user purchases and/or subscribes to the application. The contextual demonstration of an application hosted on a multi-tenant database enables the contextual demonstration to react to explicit inputs and implicit inputs received from a user's electronic device to customize the content of the presentation or demonstration accordingly.

System Overview

FIG. 6 illustrates a block diagram of an exemplary environment 610 wherein an on-demand database service might be used. Environment 10 may include user systems 612, network 614, system 616, processor system 617, application platform 18, network interface 620, tenant data storage 622, system data storage 624, program code 626, and process space 628. In other embodiments, environment 10 may not have all of the components listed and/or may have other elements instead of, or in addition to, those listed above.

Environment 610 is an exemplary environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol. User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements an exemplary web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 16 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted on system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates the exemplary environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 10001-1000N, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 1000 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 34 that provides a programming language style interface extension to API 732. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 7001 might be coupled via the network 614 (e.g., the Internet), another application server 700N-1 might be coupled via a direct network link, and another application server 700N might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Those skilled in the art will appreciate that the elements and features of the embodiments described herein and illustrated in the figures herein can be optionally included to achieve the benefits of the presently disclosed surface mountable navigation device with tactile response. Additionally, those skilled in the art will appreciate that features in each of the figures described herein can be combined with one another and arrange to achieve the described benefits of the presently disclosed contextual demonstration of an application hosted on a multi-tenant database system. Therefore, the scope of the appended claims should be accorded the broadest interpretation so as to encompass all such modifications and similar arrangements.

1. A method for providing a contextual demonstration of an application hosted on a multi-tenant database system, the method comprising:
sending instructions to display a user interface on a display of an electronic device, the user interface comprising at least one pre-defined field;
receiving an explicit input made at the user interface, the explicit input corresponding to one of the at least one pre-defined fields;
receiving a selection of a type of simulation;
processing the explicit input and the selection of the type of simulation to generate at least one output, each output representing a correlation between the explicit input and at least one of the at least one pre-defined fields;
generating a presentation based at least in part on the at least one output and the selection of the type of simulation; and
sending instructions to display the presentation at the user interface.

2. The method of claim 1, wherein the application is a customer relationship management application.

3. The method of claim 1, wherein receiving an explicit input further comprises receiving at least one explicit input.

4. The method of claim 1, wherein the type of simulation includes one of a sales simulation, a service simulation, a mobile communication simulation, and a meeting simulation.

5. The method of claim 1, wherein the presentation is a sales presentation, a preview presentation, and a trial simulation of the application.

6. The method of claim 1, further comprising receiving an implicit input from the device on which the user interface is displayed.

7. The method of claim 6, wherein processing the explicit input and the selection of the type of simulation to generate at least one output, further comprises processing the implicit input, and wherein the at least one output further represents a correlation between the explicit input, the implicit input, and at least one of the one of the at least one pre-defined fields.

8. The method of claim 6, wherein:
the implicit input comprises a current location of a device on which the user interface is displayed;
the method further comprises retrieving contextual data based on at least the current location and at least one of the explicit input received; and
the presentation further comprises the contextual data.

9. The method of claim 8, wherein the contextual data comprises at least one of a contact and a business having the explicit input in common and having a location with a predetermined distance of the current location of the user of the user interface.

10. The method of claim 1, wherein processing the explicit input and the selection of the type of simulation to generate at least one input comprises:
determining an inferential correlation between the explicit input and the at least one pre-defined fields;
retrieving inferential data corresponding to the inferential correlation;
generating an inferential output representing the inferential data;
wherein the presentation is further based on the inferential output.

11. The method of claim 10, wherein the inferential data is retrieved from a remote database communicatively coupled to the multi-tenant database system.

12. The method of claim 10, wherein the inferential data includes contact data associated with but not directly corresponding to the explicit input and at least one of the at least one pre-defined fields.

13. The method of claim 12, wherein the contact data comprises at least one of a name, an address, a phone number, an email address, and an occupation.

14. The method of claim 10, wherein:
the explicit input comprises at least one explicit input, each explicit input corresponding to at least one of the pre-defined fields; and
the inferential data comprises at least one of a contact and a business having at least one explicit input in common.

15. The method of claim 1, further comprising sending instructions to display a prompt at the user interface, after a conclusion of the presentation, the prompt providing at least one user-selectable option.

16. The method of claim 15, wherein the at least one user-selectable option includes at least one of a purchase option, a share option, a modify option, and a new presentation option.

17. A machine-readable medium carrying one or more sequences of instructions for contextual demonstration of an application hosted on a multi-tenant database system, which instructions, when executed by one or more processors, cause the one or more processors to carry out the steps of:
sending instructions to display a user interface on a display of an electronic device, the user interface comprising at least one pre-defined field;
receiving an explicit input made at the user interface, the explicit input corresponding to one of the at least one pre-defined fields;
receiving a selection of a type of simulation;
processing the explicit input and the selection of the type of simulation to generate at least one output, each output representing a correlation between the explicit input and at least one of the at least one pre-defined fields;
generating a presentation based at least in part on the at least one output and the selection of the type of simulation; and
sending instructions to display the presentation at the user interface.

18. The machine-readable medium of claim 17, wherein processing the explicit input and the selection of the type of simulation to generate at least one input comprises:
determining an inferential correlation between the explicit input and the at least one pre-defined fields;
retrieving inferential data corresponding to the inferential correlation;
generating an inferential output representing the inferential data;
wherein the presentation is further based on the inferential output.

19. An apparatus for displaying a contextual presentation of an application hosted on a multi-tenant database, the apparatus comprising:
a processor; and
one or more stored sequences of instructions which, when executed by the processor, cause the processor to carry out the steps of:
sending instructions to display a user interface on a display of an electronic device, the user interface comprising at least one pre-defined field;
receiving an explicit input made at the user interface, the explicit input corresponding to one of the at least one pre-defined fields;
receiving a selection of a type of simulation;
processing the explicit input and the selection of the type of simulation to generate at least one output, each output representing a correlation between the explicit input and at least one of the at least one pre-defined fields;
generating a presentation based at least in part on the at least one output and the selection of the type of simulation; and
sending instructions to display the presentation at the user interface.

20. The apparatus of claim 19 further comprising a touch-sensitive display.
